(19) United States
(12) Patent Application Publication
(10) Pub. No.: US 2019/0002047 A1
(43) Pub. Date: Jan. 3, 2019

(54) Tracking Unit for a Human-Powered Vehicle

(71) Applicant: BikeFinder AS, Stavanger (NO)

(72) Inventors: Ole Martin Ølmheim, Stavanger (NO); Erik Brodahl, Sandnes (NO)

(73) Assignee: BikeFinder AS, Stavanger (NO)

(21) Appl. No.: 16/064,529

(22) PCT Filed: Dec. 21, 2016
(86) PCT No.: PCT/NO2016/050264

§ 371 Date: Jun. 21, 2018

(30) Foreign Application Priority Data
Dec. 22, 2015 (NO) 20151780

(51) Int. Cl. B62H 5/20; B62K 19/30

(52) U.S. Cl. CPC B62H 5/20; G01S 19/16; B62K 2208/00; B62K 19/30

(57) ABSTRACT

A tracking unit is for a human-powered vehicle comprising a frame. The tracking unit has a tracker, such as a GPS and/or GSM unit, and an antenna for allowing the tracker to communicate. The tracker is adapted to be placed inside the frame of a human-powered vehicle. The tracking unit includes a wire adapted to extend from the tracker, through a hole below a crank in the frame, to the antenna adapted to be mounted externally on said frame at or near said hole.

### FIELD

The present invention relates to a tracking unit for a human-powered vehicle, the human-powered vehicle comprising a frame. The tracking unit comprises a tracker, such as a GPS unit and/or a GSM unit, and an antenna. The invention also relates to a human-powered vehicle comprising the tracking unit. Said human-powered vehicle may be a bicycle.

### BACKGROUND

Theft of human-powered vehicles, such as bicycles, is a large and increasing problem. Expensive bicycles have even been reported to be the aim of organized criminals. One possible counter-measure to the increasing problem is to install tracking units in said vehicles. Said tracking units rely on antennas for communicating with other devices.

Tracking units for bicycles that use GPS and/or GSM trackers are known. US2013150028 has addressed the issue of facilitating communication by configuring the water bottle rack to enclose the antenna. This solution has several drawbacks, such as that not all human-powered vehicles are is equipped with water bottle racks. In some cases, such as for downhill bikes, having a water bottle rack might not be practical. Owners of human-powered vehicles might also not want a water bottle rack for aesthetic reasons.

### SUMMARY

The invention has for its object to remedy or to reduce at least one of the drawbacks of the prior art, or at least provide a useful alternative to prior art.

The object is achieved through features, which are specified in the description below and in the claims that follow.

The invention is defined by the independent patent claims. The dependent claims define advantageous embodiments of the invention.

In a first aspect, the invention relates to a tracking unit for a human-powered vehicle. The human-powered vehicle comprises a frame. The tracking unit comprises a tracker, such as a GPS unit and/or a GSM unit (inside the frame), and an antenna. Said tracking unit further comprises a wire adapted to extend from the tracker, through a hole below the crank in the frame of said human-powered vehicle, to an antenna adapted to be mounted externally on said frame at or near said hole. The tracking unit is adapted to be placed inside the frame of the human-powered vehicle.

The tracking unit according to the present invention aims at offering a better antenna solution for a tracking unit, compared to the prior art. An antenna mounted externally on the frame at or near a hole below the crank has several advantages:
There may not be a need for new holes in the frame for a wire to extend through from an internally placed tracker to an externally mounted antenna, as the hole below the crank can be used for this purpose.
Proximity from the hole to the antenna means that the part of the antenna extending on the exterior of the frame may be small, making it less exposed to tampering by an evil-doer.
The area by the crank may be relatively hard to reach for an evil-doer seeking to tamper with the antenna or the wire, compared to alternatives such as a bottle rack or the seat.

Adding more alternative positions to place an antenna to the art may in itself have advantages, as it is may be harder for an evil-doer to find an antenna on a bike protected by a tracking unit if there are several possible alternative antenna positions to check. If it takes more time for the evil-doer on average to find an antenna to disable a tracking unit, the risk involved in stealing a human-powered vehicle will increase. Furthermore, a solution with an antenna under the crank may be particularly advantageous as it may be more time consuming and cumbersome to check that location than other known alternative locations, such as in, at or under a water bottle rack or a seat. The seat and the water bottle rack of a standing bicycle are positions more available to an evil-doer compared to a position near the crank, both visually and for using hands to feel for or try to disable an antenna.

The tracking unit, when installed in a human-powered vehicle, may be protected from tampering by at least partly protecting parts of the tracking unit that are not enclosed by a frame. This may be done by a layer of protective material, or by using fastening means of protective material. The protective material may be a two-component epoxy material, a polyurethane, a polycarbonate, a nitrogen based thermoset polymer, a ceramic material, a thermoplastic two-component material or a mouldable bulletproof material. Protecting the tracking unit's external parts with protective material protects the tracking unit's ability to communicate from being disabled. By protecting the tracking unit it will become harder and more time-consuming for any evil-doer to disable the tracking unit.

The tracking unit may also comprise a backup battery for providing the tracking unit with power in situations wherein other power sources are disabled, not functioning or not present. A backup energy source will reduce the tracking unit's downtime; time during which the tracking unit is not working as intended. The tracking unit is working as intended if it is consistently monitoring and communicating the human-powered vehicle's position.

The tracking unit may also comprise a motion detection means, such as an accelerometer, a tilt sensor and/or a gyroscope, for detecting movement, wherein the tracking unit is configured for conditional deactivation of the tracking unit when no movement is detected. In an embodiment comprising motion detection means, the term working as intended will refer to a situation where the tracking unit is consistently monitoring and communicating a human-powered vehicle's position unless the tracking unit is temporarily deactivated by the lack of movement registered by the motion detection means. A tracking unit comprising motion detection means is advantageous because deactivation of the tracking unit during standstill will reduce power consumption and thereby increase battery lifetime.

Furthermore, the tracking unit may also comprise an expansion device for securely fastening the tracking unit by expansion internally in a human-powered vehicle frame. By securely fastening the tracking unit it may be kept from moving relative to the frame. Keeping the tracking unit from moving relative to the frame may be advantageous, as such movement may cause damage to the tracking unit, to connections between parts of the tracking unit, or to the frame.

In a second aspect the invention relates to a human-powered vehicle comprising the tracking unit according to the first aspect of the invention.

The term underside refers to the side of the human-powered vehicle facing the ground when the human-powered vehicle is in normal use, internal and internally refers to in a cavity on the inside of the frame of the human-powered vehicle, and external and externally refers to the outside of the frame of the human-powered vehicle.

In one embodiment the antenna may be mounted on the underside of the frame of the human-powered vehicle, where it may be mounted using two holes for holding a battery and a junction box. This embodiment requires that the human-powered vehicle comprises two holes as described.

A second possible embodiment of the invention has the antenna placed on the underside of the frame of the human-powered vehicle, where it may be mounted using a drainage hole under a crank. This embodiment requires that the human-powered vehicle comprises a drainage hole under a crank.

In a third embodiment, the antenna may be built into a plastic gear wire guide on the underside of the frame of the human-powered vehicle, where the gear wires extends from internally to externally on the frame. This may be a particularly advantageous embodiment, as the plastic gear wire guide offers tamper protection by hiding the antenna for an evil-doer.

In a fourth embodiment, the antenna may be placed on the upper side of a lower part of the frame of the human-powered vehicle. By upper side is meant the side facing away from the ground when the human-powered vehicle is in normal use. In this embodiment, mounting holes in the frame for mounting a battery may be used for mounting the antenna. This embodiment requires that the human-powered vehicle comprises such mounting holes, or other means for mounting the antenna to the frame in such a position.

In embodiments comprising an antenna mounted on the underside of the frame of a human-powered vehicle, the antenna is preferably mounted in such a way that it has a minimum angle relative to the ground. An angle is preferred for the antenna to send and/or receive signals of sufficient quality consistently enough for the tracking unit to work as intended.

It is further preferred, for all embodiments which comprises an antenna mounted on the exterior of the frame, that the antenna protrudes from the frame to ensure that signals of sufficient quality can be sent from and/or received by the antenna consistently enough for the tracking unit to work as intended.

The human-powered vehicle may comprise an electric gear shifter, and a battery coupled to the electric gear shifter for supplying power thereto. In an embodiment the battery may further be coupled to the tracking unit for supplying power thereto. Using an already existing battery solution is advantageous, as it saves cost, weight and space by not requiring a dedicated battery exclusively for the tracking unit to be added.

The human-powered vehicle may be partly electrically powered, in which case it will comprise an electric motor and a power source for the electric motor. The power source for the electric motor may be the power source for the tracking unit.

In a third aspect the invention relates to a bicycle comprising the tracking unit according to the second aspect of the invention.

In a fourth aspect, the invention relates to a tracking unit comprising a tracker such as a GPS and/or a GSM unit, the tracking unit further comprising an antenna, the tracking unit being arranged to receive power from a power supply, wherein the tracking unit is arranged to be placed on the exterior of a frame. The tracking unit may comprise the power supply. The power supply may be a battery. The tracking unit may be configured to receive power from a power source for an electric motor for a partly electrically powered human-powered vehicle or from a power supply for an electric gear shifter.

The tracking unit according to the fourth aspect of the invention may be arranged to be fastened to the frame of a human-powered vehicle by use of bracket placed on the inside of the frame and connection means extending from the tracking unit through a hole in the frame. The tracking unit may be fastened to the frame by other means, such as by use of a glue, by welding or by any other means suitable for the purpose.

In a fifth aspect, the invention relates to a human-powered vehicle comprising the tracking unit according to the fourth aspect of the invention, wherein the tracking unit is placed on the exterior of the frame of the human-powered vehicle in close proximity to the crank. The tracking unit may be placed within 15 centimetres of the crank, more preferably it may be placed within 10 centimetres of the crank, even more preferably it may be placed within 5 centimetres of the crank. Having the tracking unit placed in close proximity to the crank is advantageous, as this area of a human-powered vehicle comprises equipment that may block the view of an evil-doer, making it harder to spot a tracking unit. The equipment in the area may also make it harder for an evil-doer to tamper with the tracking unit. To get a good look at the area around the crank, or to tamper with a tracking unit spotted in the area, an evil doer may have to bend, kneel or sit down, which may make his actions look more suspicious and which may increase the risk of the evil doer getting spotted and apprehended for doing something illegal.

### BRIEF DESCRIPTION OF THE DRAWING

In the following is described an example of a preferred embodiment illustrated in the accompanying drawings, wherein:

FIG. 1 shows a bicycle frame provided with an embodiment of the tracking unit in accordance with the invention.

### DETAILED DESCRIPTION OF THE DRAWING

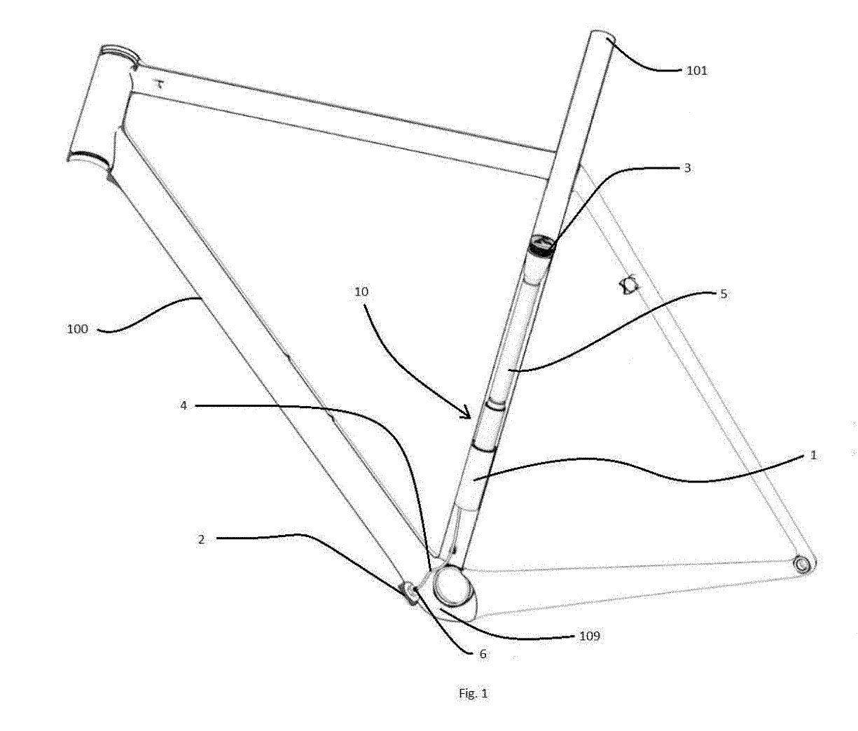

In said preferred embodiment, illustrated in FIG. 1, a tracking unit 10 is enclosed inside a bicycle frame 100, with an opening 101 in the top of the frame 100 and a further opening 109 in the bottom of the frame 100. The tracking unit 10 comprises a tracker 1 in the form of a GPS unit, an expansion mechanism 3, a battery 5, and a wire 4 extending from the tracker to an antenna 2 mounted on the exterior of the frame 100. Said wire 4 extends from the tracker 1 inside the frame 100 to the externally mounted antenna 2 through a hole 6 in the frame 100.

The parts of the tracking unit 10 provided inside of the frame 100, can be inserted through the opening in the top of the frame 101 and/or inserted through the bottom of the frame 109. The tracker 1 can be positioned above or below the battery 5. By above is meant closer to the top hole 101 in the frame 100, by below is meant closer to the bottom hole 109 in the frame 100.

In the shown embodiment the expansion mechanism 3 is positioned at the top of the tracking unit 10, with the result that no wiring has to pass by the expansion mechanism 3. The tracker 1 is mounted close to or directly below the battery 5, meaning little to no wiring is needed between the tracker 1 and the battery 5. The tracker 1 is furthermore placed close to the hole 6 on the underside of the frame, meaning that wire 4 may be short, and that little work is needed to connect the tracker 1 to the antenna 2.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

1. A tracking unit for a human-powered vehicle, the human-powered vehicle comprising a frame, the tracking unit comprising:
a tracker and an antenna for allowing the tracker to communicate with a receiver, wherein
said tracker is adapted to be placed inside the frame of a human-powered vehicle; and
said tracking unit has a wire adapted to extend from the tracker, through a hole below a crank in the frame, to the antenna adapted to be mounted externally on said frame at or near said hole.

2. The tracking unit according claim 1, wherein parts of the tracking unit that are not enclosed by the frame are at least partly protected by a tamper protection layer.

3. The tracking unit according to claim 1, the tracking unit further comprising a backup battery for providing power for the tracking unit when other power sources are disabled, not functioning or unavailable.

4. The tracking unit according to claim 1, the tracking unit further comprising a motion detection means for detecting movement, wherein the tracking unit is configured for conditional deactivation of the tracking unit when no movement is detected.

5. The tracking unit according to claim 1, the tracking unit further comprising an expansion device for securely fastening the tracking unit by expansion within a cavity in the frame.

6. A human-powered vehicle comprising:
a frame;
a tracking unit comprising a tracker and an antenna for allowing the tracker to communicate with a receiver, wherein
said tracker is adapted to be placed inside the frame; and
said tracking unit has a wire adapted to extend from the tracker, through a hole below a crank in the frame, to the antenna adapted to be mounted externally on said frame at or near said hole.

7. The human-powered vehicle according to claim 6, wherein the antenna is mounted on an underside of the frame of the human-powered vehicle, wherein the antenna is mounted using two holes for holding a battery and a junction box.

8. The human-powered vehicle according to claim 6, wherein the antenna is mounted on an underside of the frame of the human-powered vehicle, and wherein the antenna is mounted using a drainage hole under a crank.

9. The human-powered vehicle according to claim 6, wherein the antenna is adapted to be built into a plastic gear wire guide on an underside of the frame.

10. The human-powered vehicle according to claim 6, wherein the antenna is mounted on a upper side of a lower part of the frame, wherein the antenna is mounted using holes in the frame for mounting a battery.

11. The human-powered vehicle according to claim 6, wherein the antenna has a minimum angle relative to the ground.

12. The human-powered vehicle according to claim 6, wherein the antenna protrudes from the frame.

13. The human-powered vehicle according to claim 6, wherein the human-powered vehicle comprises an electric gear shifter and a battery, wherein the battery is coupled to the gear shifter for supplying power thereto, and wherein the battery is coupled to the tracking unit for supplying power thereto.

14. The human-powered vehicle according to claim 6, wherein the human-powered vehicle comprises a bicycle.
